(19) United States
(12) Patent Application Publication
(10) Pub. No.: US 2016/0180045 A1
(43) Pub. Date: Jun. 23, 2016

(54) WIRELESS BEACON DEVICES USED TO TRACK MEDICAL INFORMATION AT A HOSPITAL

(71) Applicant: EBAY INC., San Jose, CA (US)

(72) Inventor: Mobeen Syed, San Jose, CA (US)

(21) Appl. No.: 14/578,062

(22) Filed: Dec. 19, 2014

(51) Int. Cl. G06F 19/00; H04W 4/00

(52) U.S. Cl. CPC G06F 19/3418; H04W 4/008; G06F 19/322; G06F 19/327

(57) ABSTRACT

There are provided systems and methods for wireless beacon devices used to track medical information at a hospital. A hospital may set up one or more wireless beacons throughout the hospital that may connect with various devices when the devices are within a proximity range from one or more of the beacons. The devices may be connected to a user or an item within the hospital. Thus, when the device connects to a beacon, the device may be associated with a location for the beacon and instructions associated with the user or item may be retrieved. The instruction may relate to the user, such as medical histories for the user, required testing or medication for the user, or a medical chart of current medical care provided for the user. The instruction may also relate to items, such as locations for surgical equipment, use of medical equipment, and administration of medicines.

### TECHNICAL FIELD

The present application generally relates to wireless beacon devices used to track medical information at a hospital and more specifically to tracking users and items in a hospital through connections between devices associated with the users/items and wireless beacons established throughout the hospital.

### BACKGROUND

Hospitals may utilize computerized systems to assist in providing health care to patients. For example, medical history files may be stored to databases, including ones accessible to a wide range of hospitals and/or insurance providers. Prescriptions may be input into such databases and accessible by doctors, nurses, and/or pharmacists. Moreover, hospitals may utilize computer systems to provide inventory and track patients. However, one of the leading causes of death in hospitals is incorrect administration of medicines. Thus, inexperienced caretakers, such as nurses or doctors may confuse prescriptions between patients, or may incorrectly read the prescriptions and provide incorrect medications or dosages, which can be life-threatening issues. Additionally, elderly and/or psychiatric patients may be difficult to monitor throughout the hospital, as they may move outside of their authorized room. Thus, hospitals may wish to track the location of users and make sure that users are in the correct place and receiving the correct medical attention. Additional, theft of medication and hospital equipment may require additional tracking of items located within a hospital.

### BRIEF DESCRIPTION OF THE DRAWINGS

FIG. 1 is a block diagram of a networked system suitable for implementing the processes described herein, according to an embodiment;

FIG. 2 is an exemplary hospital environment having wireless beacons used to monitor user locations, medical care, and item use and locations, according to an embodiment;

FIG. 3 is an exemplary system environment showing a hospital server detecting a location of a communication device for use in determining user instructions for communication to a hospital device, according to an embodiment;

FIG. 4 is a flowchart of an exemplary process for wireless beacon devices used to track medical information at a hospital, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide wireless beacon devices used to track medical information at a hospital. Systems suitable for practicing methods of the present disclosure are also provided.

Hospitals may use short range wireless communication beacons with a device, such as through Bluetooth Low Energy (BLE) communication protocol, LTE Direct communication protocol, WiFi communication protocol, etc. These beacons may communicate with devices in order to connect with the devices and retrieve information for a user/item associated with the device. The device may correspond to a communication device, such as a mobile phone, or may also correspond to a smaller device, such as a wearable device that may offer limited functionality. The beacons may provide additional functionality, such as establishing a connection with a device and/or server associated with the hospital to access information, such as instructions, related to the user/item. The beacons may provide communications to the devices directly, including information stored in the beacons. The beacons may also provide communication with a device attached to, or in communication with, the beacon, such as the hospital's device/server.

Thus, the hospital may associate the wireless beacon(s) with locations throughout the hospital, such as a check-in desk, a patient room, a pharmacy, a surgical room, or another medical room where a procedure may be administered. The hospital may utilize the short range wireless beacon located on, connected to, or in proximity to the location within the hospital to determine the location of the user/device. For example, the beacon may employ BLE, LTE Direct, WiFi, or other communications that emit a signal receivable by the user/item's device. The communication may include an identifier for the beacon, the user, the hospital, and/or an administrator of the user/item, such as an insurance provider and/or inventory provider.

The device may passively monitor for BLE, LTE Direct, WiFi, or other communication signals from the beacon. When the device detects the signal and verifies the identifier(s) from the beacon, both the device and the beacon may ramp up in power and establish a connection. In various embodiments, the connection may further enable the device to communicate with a device/server at or associated with the hospital. The beacon may also provide check-in information for the device to a device/server administering the hospital. The beacon may be connected to a networked device for the hospital, or the beacon may include network functionality to communicate with hospital's server/device. Thus, the beacon enables the user's device to establish a connection and communicate check-in information (e.g., an identifier for the user and/or item) to a device/server associated with the hospital. The check-in may be completed automatically when the device is in range of the beacon, or may be completed after prompting a user associated with the device to check-in when the device is in range of the beacon.

Once the device is connected to the wireless beacon, the server may receive the check-in information. The server may then determine that the user/item associated with the device is in proximity to a location within the hospital. Based on the location for the user/item and the check-in information identifying the user/item, an instruction for use or information associated with the user/item (generally referred to herein as “instruction”) may be determined by the server. For example, where the device connected with the wireless beacon is associated with a user, the instruction may include one or more of a medical history file for the first user, a medical chart for the first user, a diagnostic document for the first user, a surgical document for the first user and a prescription for the first user. Thus, as the user arrives in various locations of the hospital (e.g., an entrance location, a medical/surgical room, a patient recovery room, etc.), the correct information may be recalled by the hospital's device/server for the user. The instruction may also correspond to a sub-location within the hospital that the user is required to occupy. For example, certain patients may be restricted to certain rooms (e.g., long term care, psychiatric facilities, quarantined rooms, etc.). The instruction may also, correspond to a required medical test or procedure for the user, such as an x-ray, MRI, CAT scan, administration of a medication, surgery, etc. The instruction may be input to the hospital's device/server by another user, such as a doctor, nurse, and/or insurance provider. Where the device connected with the wireless beacon corresponds to an item, such as medical/surgical equipment and/or medication, the instruction may include where the equipment/medication should be located (e.g., if the location for the wireless beacon is different than the required location, possibly indicating theft), a use of the equipment/medication by a health care provider at the location, and/or a prescription related to the item.

The instruction may be communicated to a second device in possession of a second user within or associated with the hospital. The second user may correspond to a health care provider, such as a doctor, nurse, or other hospital employee. In various embodiments, the instruction may also be stored with a medical history file for the user and/or communicated to an insurance provider. The second user may also receive updates for further connections between the device for the user/item and other wireless beacons. Thus, if the user/item is further moved throughout the hospital, the second user may be alerted of further movements. Where the second user utilizes the instruction to provide health care to the user and/or administer/use the item, the second user may update the hospital's device/server using the second device with further information related to the instruction. For example, the second user may provide further instructions for additional health care for the user, may update the user's medical history file with new information about the user (e.g., test results, further required medical attention, etc.), and/or update inventory and/or usage logs of the item's use. Thus, a user may receive at least one of a test result to the first required medical test, a second required medical test, a prescription based on the test result to the first required medical test, and a medical procedure based on the test result to the first required medical test using further instructions input by the second user. Therefore, the user/item associated with the device may receive ongoing tracking through updates of instructions associated with the check-in information used for the device associated with the user/item.

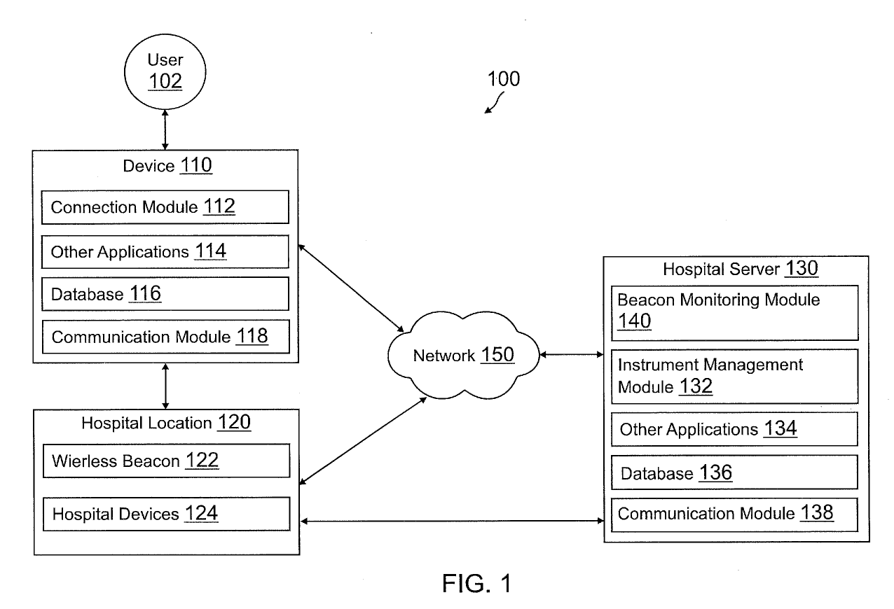

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a device 110, a hospital location 120 having a wireless beacon 122 and hospital devices 124, and a hospital server 130 in communication over a network 150. User 102, such a patient, may visit hospital location 120 in order to receive medical care. Device 110 may be utilized to connect with wireless beacon 122 and determine user 102 is located within the hospital. Thus, hospital server 130 may determine one or more instructions for the care of user 102 and communicate the instructions to one or more of hospital devices 124. In various embodiments, another device providing at least the described communication features of device 110 with wireless beacon 122 may be associated with medical and/or surgical equipment within hospital location 120 in order to track usage and/or locations of the equipment.

Device 110, wireless beacon 122, hospital devices 124, and hospital server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Device 110 may be implemented using any appropriate hardware and software configured for wired and/or wireless communication with wireless beacon 122 and/or hospital server 130. For example; in one embodiment, device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, tags or other small attachments including connection and communication modules, and/or other types of computing devices capable of transmitting and/or receiving data, such as an IPAD® from APPLE®. Although only one device is shown, a plurality of devices may function similarly. Although device 110 is shown as in possession or connected to user 102, in other embodiments, device 110 may function as a tag or other connectable device to an item, such as medical and/or surgical equipment (e.g., a diagnostic machine, surgical tools, etc.).

Device 110 of FIG. 1 contains a connection module 112, other applications 114, a database 116, and a communication module 118. Connection module 112 and other applications 114 may correspond to executable processes, procedures, and/or applications with associated hardware. In other embodiments, device 110 may include additional or different hardware and software as required. For example, device 110 may include less, additional, or different software as required by the implementation of device 110 (e.g., a small personal BLE/LTE Direct wearable beacon, RFID tag, or other small device used to send and/or receive data).

Connection module 112 may correspond to one or more processes to execute modules and associated devices of device 110 to establish a connection with wireless beacon 122, including a check-in with hospital location 120 and/or a sub-location within hospital location 120 associated with wireless beacon 122. In this regard, connection module 112 may correspond to specialized hardware and/or software utilized by device 110 to connect to wireless beacon 122 in order to enable hospital server 130 to access and/or determine instructions for user 102 and provide healthcare to user 102 while user 102 is at hospital location 120. In other embodiments, connection module 112 may be utilized to connect to wireless beacon 122 while device 110 is attached to, in proximity to, and/or otherwise associated with an item (e.g., medical/surgical equipment) at a hospital. In such embodiments, connection module 112 may be utilized to access/determine instructions for use of the item and/or determine proper locations for the item to deter or prevent theft. In this regard, connection module 112 may receive short range wireless communications from wireless beacon 122 and transmit information to wireless beacon 122, including identification information for user 102 or the item (e.g., an identifier or other token identifying user 102 or the item) and/or check-in information for a check-in process with hospital location 120 that associates device 110 with the location corresponding to wireless beacon 122. As will be discussed in more details herein, wireless beacon 122 may be range limited to correspond to a small area nearby or corresponding to hospital location 120, thereby locating device 110 within a sub-area of hospital location 120 (e.g., a hospital check-in, a medical/surgical room, a patient room, a particular ward, a pharmacy, etc.). Thus, in various embodiments, hospital location 120 may include a plurality of beacons functioning similar to wireless beacon 122.

Connection module 112 may execute in the background of an operating system of device 110 and be configured to establish connections, using communication module 118 of device 110, with wireless beacon 122. In other embodiments, connection module 112 may instead be executed on device 110 continuously to form a connection with wireless beacon 122, for example, as the operating hardware and software of device 110. Thus, the connection may be established with or without user input from user 102. For example, wireless beacon 122 may broadcast a token, such as a universally unique identifier (UUID), for reception by connection module 112, as will be explained in more detail herein. Connection module 112 may utilize communication module 118 of device 110 to receive the token from wireless beacon 122. If connection module 112 acknowledges the UUID as identifying wireless beacon 122, hospital server 130, and/or an administrator for hospital location 120 (e.g., a hospital owner, physician, doctor, nurse, health care provider, insurance provider etc.), connection module 112 may transmit an identifier corresponding to user 102, the item associated with device 110, and/or device 110 back to wireless beacon 122. Connection module 112 may utilize communication module 118 of device 110 to communicate with wireless beacon 122 (e.g., over near field communication, Bluetooth, Bluetooth Low Energy, radio, infrared, LTE Direct, or other connection). The identifier from device 110 may include, be transmitted with, concatenated with, or otherwise bundled with the identifier received from wireless beacon 122. In other embodiments, different information may be transmitted to wireless beacon 122, such a name or other personal information for user 102, a prescription or prescription identifier for user 102, an identifier for a caretaker, doctor, nurse, etc., for user 102, a name or identification of an item within a hospital, a description of the item, or other information. Thus, the information transmitted to wireless beacon 122 does not need to be utilized to process and/or complete a check-in with hospital server 130 in all embodiments.

However, in other embodiments, connection module 112 may further correspond to an application utilized by device 110 with wireless beacon 122 to complete a check-in for hospital location 120 corresponding to wireless beacon 122 and/or a sub-location of hospital location 120 corresponding to wireless beacon 122. The check-in with hospital location 120 may correspond to a process to log in to a user account of user 102 with hospital server 130 and/or an administrator of hospital location 120. The check-in process may then associate user 102 with hospital location 120 and/or wireless beacon 122 used to connect to device 110. In other embodiments, the check-in may provide and/or verify the identity of user 102, including transmission of an identifier for user 102 and/or device 110. Thus, hospital server 130 and/or the administrator of hospital location 120 may be informed that user 102 is in proximity to hospital location 120 and/or sub-locations within hospital location 120. As previously discussed, in other embodiments, a check-in need not be processed and/or completed to associate user 102 with the hospital location 120. Thus, other connections and data transfers to wireless beacon 122 may be sufficient to associate user 102 with hospital location 120.

Device 110 includes other applications 114 as may be desired in particular embodiments to provide features to device 110. For example, other applications 114 may include security applications for implementing client-side security features, programmatic client applications for interfacing with appropriate application programming interfaces (APIs) over network 150, or other types of applications. Additionally, where device 110 corresponds to a communication device, other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with a payment provider. Other applications may include mapping applications and/or social networking applications. Other applications 114 may include device interfaces and other display modules that may receive input from user 102 and/or output information to user 102. Other applications 114 may contain software programs, executable by a processor, including a graphical user interface (GUI) configured to provide an interface to the user. However, where device 110 may correspond to a small tag used only to form connections with wireless beacon 122, device 110 may not include other applications 114.

Device 110 may further include database 116 which may include, for example, identifiers such as operating system registry entries, cookies associated with connection module 112 and/or other applications 114, identifiers associated with hardware of device 110, or other appropriate identifiers, such as identifiers used for user/item/device authentication or identification. Identifiers in database 116 may be used by a service provider, such as hospital server 130 and/or an administrator of hospital location 120, to associate device 110 with a particular user, user account, user history, item, item information, and/or item history. Database 116 may include user device tokens and/or encryption keys, including an encryption key of wireless beacon 122, hospital server 130, and/or an administrator of hospital location 120. Database 116 may include identifying information for tokens enabling connection module 112 to identify wireless beacon 122, hospital server 130, and/or an administrator of hospital location 120 when receiving a corresponding check-in token. Database 116 may further include instruction related to user 102 and/or an item (e.g., medical/surgical equipment) associated with device 110.

Device 110 includes at least one communication module 118 adapted to communicate with wireless beacon 122, hospital device 124, and/or hospital server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 122 using short range communications, such as Bluetooth Low Energy, LTE Direct, radio frequency, infrared, Bluetooth, and near field communications.

Hospital location 120 may correspond to a hospital, urgent care facility, emergency care provider location, or other health care location, including doctor, dentist, psychologist, or other health care provider location. In this regard, hospital location 120 may include at least one location associated with wireless beacon 122, such as the overall location and/or a sub-area/location of hospital location 120. Moreover, hospital location 120 may include health care providers (e.g., doctors, nurses, administrative staff), health care equipment (e.g., medical/surgical equipment), and/or other necessary people and items to provide care to at least user 102. Hospital location 120 may include a plurality of sub-locations to provide specialized care, dispense medications, and/or provide temporary rooms for patients a health care professional may wish to oversee during recovery. Although only one hospital location is shown, a plurality of hospital locations may function similarly. Additionally, hospital server 130 may be associated with only hospital location 120 or may be associated with a plurality of hospital locations.

Hospital location 120 of FIG. 1 further includes wireless beacon 122 and hospital devices 124. Wireless beacon 122 and hospital devices 124 may include hardware and software necessary to execute the processes and functions as described below. In other embodiments, hospital location 120 may include devices, servers, displays, mechanisms, hardware, and/or software as required.

Wireless beacon 122 may be maintained, for example, by an administrator of hospital location 120 and/or hospital server 130. Wireless beacon 122 may be implemented using any appropriate hardware and software configured for wireless communication with device 110. For example, in one embodiment, wireless beacon 122 may be implemented as a dongle device including a hardware processor and a communication module, for example, attached to, connected with, and/or corresponding to hospital location 120 and/or a sub-area/location within hospital location 120. Wireless beacon 122 may also be implemented as devices incorporated within a personal computer (PC), a smart phone, laptop computer, and/or other types of computing devices capable of transmitting and/or receiving data, such as an IPAD® from APPLE®. Wireless beacon 122 may also act as a stand-alone device including a processor, communication module, and/or network interface component configured to communicate with device 110 and/or hospital server 130. Although wireless beacon 122 is described singly, a plurality of wireless beacons may correspond to hospital location 120 and/or a plurality sub-areas/locations within hospital location 120, which may function similarly.

Wireless beacon 122 may be located within, on, near, or corresponding to hospital location 120 (e.g., an entryway of hospital location 120, a room within hospital location 120, etc.). As previously discussed, hospital location 120 may correspond to a health care provider facility. Thus, wireless beacon 122 may be located within to hospital location 120 and, in various embodiments, connected with hospital devices 124, either directly or over a communication channel. Wireless beacon 122 may be limited, either by signal range or physical properties of hospital location 120/wireless beacon 124, to connect to device 110 only when device 110 is within a certain distance range of hospital location 120. For example, wireless beacons 122 may only connect to device 110 within hospital location 120. In various embodiments, wireless beacon 122 may be located within a sub-area/location of hospital location 120 and configured to only connect to devices within the sub-area/location. Thus, wireless beacon 122 may be associated with the sub-area/location such that when device 110 connects with wireless beacon 122, device 110 may be associated with the area (e.g., an entry/hospital check-in location, a doctor's office, a specialized health care room (e.g., surgery, psychiatric ward, infectious disease area, quarantined area, etc.), and/or a patient room number).

Wireless beacon 122 of FIG. 1 contains processes, procedures, and/or applications executable by a hardware processor, for example, a software program, configured to interact with device 110 and/or hospital server 130. Thus, regardless of the implementation of wireless beacon 122 as discussed above, wireless beacon 122 may utilize a connection/check-in process and include or be connected to a communication module. In other embodiments, wireless beacon 122 may include additional or different hardware and software as required.

Wireless beacon 122 may include an application for transmitting requests to establish a connection between a device (e.g., device 110) and wireless beacon 122. The requests may be unique to wireless beacon 122, thereby identifying wireless beacon 122. Wireless beacon 122 may utilize short range wireless communications of wireless beacon 122 to transmit the requests to establish a connection, including an identifier such as a Universally Unique Identifier (UUID). If device 110 receives a request to establish the connection with wireless beacon 122 and responds with an identifier for user 102, an identifier for the item(s) attached or associated with device 110, and/or an identifier for device 110 (potentially including the UUID and other information necessary to identify the aforementioned user/item/device), wireless beacon 122 to ramp up in power and create a connection between device 110 and wireless beacon 122.

Wireless beacon 122 may transmit the request to establish the connection with wireless beacon 122 as a short range wireless communication (e.g. a BLE protocol communication) including a “wake up” process for check-in application 112 of device 110 and/or a token for wireless beacon 122 transmitting the request. In other embodiments, the request and/or connection may utilize near field communication, radio communication, infrared communication, or Bluetooth communication. Additionally, although wireless beacon 122 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacon 122 (e.g., device 110) and establishment of a connection for data transfers. In other embodiments, wireless beacon 122 may correspond to other devices, such as WiFi capable devices, near field communication devices, etc.

The request may be specific to device 110 by including information that is specific to user 102, the item associated with device 110, and/or device 110, such as a name, identifier, or device identifier. The information specific to user 102/the item may be determined from information previously provided to hospital location 120 and/or hospital server 130 (e.g., a medical history file, a medical/surgical procedure request, a prescription, information about the item and/or item use, etc.). Thus, in certain embodiments, only device 110 will pick up and authenticate the request. In other embodiments, only device 110 may pick up the request if wireless beacon 122 is range limited to only transmit the request to devices within a certain proximity to sub-areas/locations within hospital location 120. The range limitation of wireless beacon 122 may be fixed to a specific area within, surrounding, or nearby hospital location 120, or may be adjusted based on a size of hospital location 120, area hospital location 120 is located, etc.

After wireless beacon 122 receives check-in information (e.g., an identifier) from device 110, wireless beacon 122 may determine device 110 is in proximity to wireless beacon 122 and thus hospital location 120. Wireless beacon 122 may pass the check-in information to hospital devices 124 and/or hospital server 130 to associate device 110 with the wireless beacon 122, and thus, the location for wireless beacon. Hospital server 130 may then determine instructions for user 102 or the item associated with device 110, as discussed herein.

Wireless beacon 122 may utilize a communication module to communicate the check-in information received from device 110 to hospital devices 124, which may also communicate the check-in information to hospital server 130. However, in other embodiments, wireless beacon 122 may utilize a network connection of wireless beacon 122 to communicate the check-in information to hospital server 130 directly. Thus, wireless beacon 122 includes a communication module adapted to communicate with device 110, hospital devices 124, and/or hospital server 130. The communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communication module of wireless beacon 122 may also communicate with device 110 and/or hospital server 130 using short range communications, such as Bluetooth Low Energy, LTE Direct, WiFi, radio frequency, infrared, Bluetooth, and near field communications (e.g., if hospital server 130 is local to hospital location 120).

Hospital devices 124 may be maintained, for example, by an administrator for hospital location 120 and/or hospital server 130. In this regard, hospital devices 124 include one or more processing applications which may be configured to interact with device 110 and/or hospital server 130 to receive instructions and/or locations associated with device 110 when device 110 connects with wireless beacon 122. For example, hospital devices 124 may display instructions for health care of user 102 where device 110 is associated with user 102 (e.g., a medical chart, a medical history file, a required medical/surgical operation, a prescription, a medicine administration procedure, a ward or location required for treatment of user 102, etc.). Where device 110 may be associated with an item at a hospital (e.g., medical/surgical equipment), hospital devices 124 may receive operation procedures for the item, proper locations for the item to prevent or deter theft, etc. Thus, hospital devices 124 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Moreover, in various embodiments, one or more of the applications, processes, and/or features discussed below in reference to hospital server 130 may be included in one or more of hospital devices 124 (e.g., instruction management module used to enter instructions for user 102 and/or the item).

Hospital server 130 may be implemented using any appropriate hardware and software configured for wired and/or wireless communication with device 110, wireless beacon 122, and/or hospital devices 124. Hospital server 130 may provide monitoring of one or more wireless beacons, such as wireless beacon 122, in order to receive check-in information for device 110 and determine instructions for the user/item associated with device 110. Hospital server 130 may also provide for establishing and managing instructions for use with devices and associated users/items. Although a server is shown, the server may be managed or controlled by any suitable processing device. Although only one server is shown, a plurality of servers may function similarly. Moreover, in various embodiments, one or more of the applications, processes, and/or features discussed below in reference to hospital server 130 may be included in hospital devices 124, and vice versa.

Hospital server 130 of FIG. 1 contains a beacon monitoring module 140, a instruction management module 132, other applications 134, a database 136, and a communication module 138. Beacon monitoring module 140, instruction management module 132, and other applications 134 may correspond to processes, procedures, and/or applications executable by a hardware processor, for example, a software program. In other embodiments, hospital server 130 may include additional or different software as required.

Beacon monitoring module 140 may correspond to one or more processes to execute modules and associated devices of hospital server 130 to process check-in information for device 110 when device 110 connects with wireless beacon 124. In this regard, beacon monitoring module 140 may correspond to specialized hardware and/or software utilized by hospital server 130 to receive check-in information from wireless beacon 122 and determine instructions associated with device 110. The check-in information may include log in information for a user account with hospital server 130 and/or an administrator for hospital location 120 and thus beacon monitoring module 140 may verify the account information. For example, the check-in information may include an identifier or other account information for a user account of user 102. However, in embodiments where a user account has not been previously established by user 102, beacon monitoring module 140 may receive other information identifying user 102, including a user name/identifier, user device identifier, an identifier for an account with another server, or other information. Additionally, such check-in information may be associated with an item associated with device 110. Thus, beacon monitoring module 120 may identify the item using the check-in information. Wireless beacon 122 may also provide a location associated with wireless beacon 122 to beacon monitoring module 140 when communicating the check-in information to hospital server 130. However, in other embodiments, beacon monitoring module 140 may access a location for wireless beacon 122 from previously entered/received information, such as information stored to database 136.

The cheek-in and location information may be used to identify instructions associated with device 110. For example, the check-in information may include an identifier for user 102 that enables hospital server 130 to identify a medical chart, medical history file, request for a medical/diagnostic/surgical test, a prescription, or other medical care information. Where device 110 is associated with an item (e.g., medical/surgical equipment), instruction for use, operation, storage, and/or proper locations for the item may be accessed by beacon monitoring module 140. Beacon monitoring module 140 may then communicate the instruction to hospital devices 124, which may present the instruction(s) to one or more health care providers. Beacon monitoring module 140 may then receive further information associated with device 110, such as additional check-in information for device 110 with other wireless beacons to determine the location of device 110 (and thus user 102 and/or the item at hospital location 120). Beacon monitoring module 140 may further determine the instructions based on the location of device 110. For example, instructions may be tied to specific locations, such as retrieval of a patient medical history at a hospital entryway and administration of a certain medication at a pharmacy. Thus, where wireless beacon 122 is associated with a sub-area/location of hospital location 120, the instructions for that sub-area/location may be determined using the check-in information with the location information. Hospital server 130 may further receive further instructions for use with device 110, which may be accessed by beacon monitoring module 140 on future check-ins by device 110 with one or more wireless beacons.

Instruction management module 132 may correspond to one or more processes to execute modules and associated devices of hospital server 130 to establish, manage, and maintain instructions for one or more users and/or devices. In this regard, instruction management module 132 may correspond to specialized hardware and/or software utilized may be configured to accept instructions from one or more parties, enter the instructions to a database for storage, update the instructions based on changes made to the instructions or new instructions, and/or provide the instructions to one or more third parties, such as other hospital, insurance providers, health care providers, etc. In this regard, a party, such as user 102, a physician, doctor, nurse, caretaker, administrator, health insurance provider, and/or other party, may enter instructions to instruction management module 132, for example, through hospital devices 124 and/or other devices (e.g., devices at a doctor's office, etc.). As discussed herein, instructions may correspond to instructions to provide healthcare to user 102 (e.g., required medical tests, procedures, prescriptions, etc.) and/or associated with user 102's healthcare (e.g., medical charts, medical history files, medical allergies, etc.). In other embodiments, the instructions may correspond to a use of an item in a hospital (e.g., instructions on how to use a medical device/scanner, etc.), who to use the item with in the hospital (e.g., an instruction to use a medical device with user 102), and/or where the item should be located (e.g., proper placement and/or storage, identification of unauthorized places for the item to deter/prevent theft). Instruction management module 132 may store the instruction(s) to database 136 for use by beacon monitoring module 140, as discussed herein.

Instruction management module 132 may also receive updates to instructions for use with device 110, such as a test result, another medical test, a prescription based on the result of a medical test, a medical procedure based on the test result, etc. The update may also correspond to an update of a medical chart and/or medical history file. The update may correspond to changes in previous health care information and/or health care providers/procedures. Where device 110 is associated with an item at hospital location 120, the update may correspond to a new patient's test instructions, a new use/procedure for a medical/surgical device, a new location for use/storage of the item, etc. Instruction management module 132 may update the instructions in database 136 using the update to reflect the most recent information received. Additionally, instruction management module 132 may update any instructions communicated to hospital devices 124.

Hospital server 130 includes other applications 134 as may be desired in particular embodiments to provide features to hospital server 130. For example, other applications 134 may include security applications for implementing client-side security features, programmatic client applications for interfacing with appropriate application programming interfaces (APIs) over network 150, or other types of applications. In various embodiments, other applications 134 may include third party applications, such as applications associated with a health care provider and/or health insurance provider. Other applications 114 may include server interfaces and other display modules that may receive input from and provide output to device 110, hospital devices 124, and/or other devices/servers. Other applications 134 may contain other software programs, executable by a processor, including a graphical user interface (GUI) configured to provide an interface to the user.

Hospital server 130 may further include database 136 which may include, for example, identifiers such as operating system registry entries, cookies associated with beacon monitoring module 140, instruction management module 132, and/or other applications 134, identifiers associated with hardware of hospital server 130, or other appropriate identifiers, such as identifiers used for payment/user/device authentication or identification. Database 136 may also store the aforementioned instructions for use with device 110 when device 110 connects to wireless beacon 122, such as instructions related to user 102 or an item associated with device 110. Database 136 may also store updates to instructions, as well as locations for wireless beacons, which may be used to locate the proper instructions for device 110.

Hospital server 130 includes at least one communication module 138 adapted to communicate with device 110, wireless beacon 122, and/or hospital devices 124. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with wireless beacon 122 and/or merchant devices 124 using short range communications, such as Bluetooth Low Energy, LTE Direct, radio frequency, infrared, Bluetooth, and near field communications.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

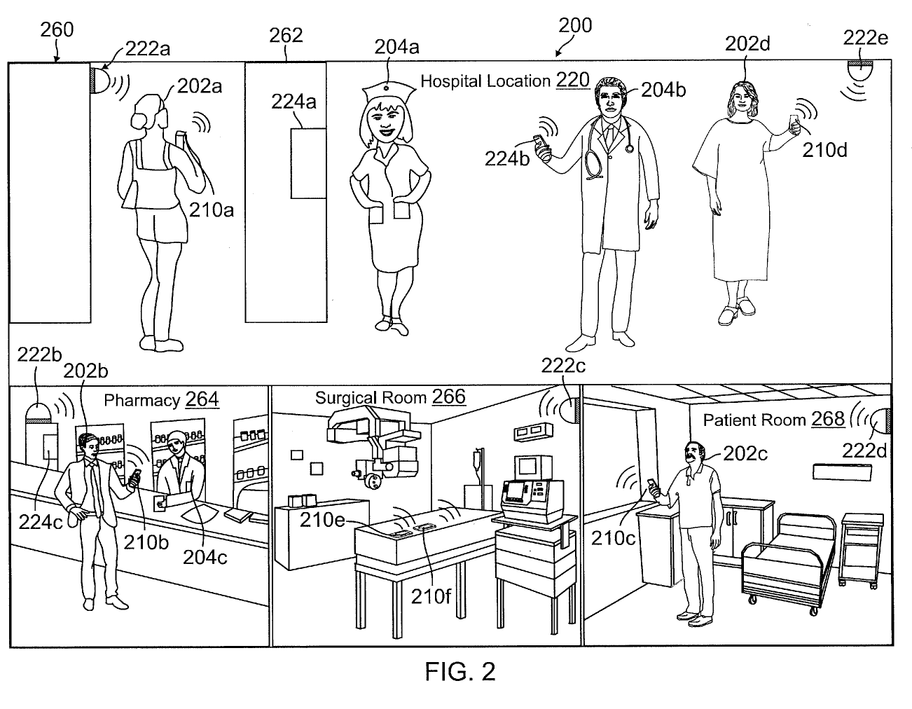

FIG. 2 is an exemplary hospital environment having wireless beacons used to monitor user locations, medical care, and item use and locations, according to an embodiment. Environment 200 of FIG. 2 includes a hospital location 220 having a wireless beacon 222a, a wireless beacon 222b, a wireless beacon 222c, a wireless beacon 222d, and a wireless beacon 222e corresponding generally to hospital location 120 having wireless beacon 122, respectively, of FIG. 1. Environment 200 further includes a user 202a, a user 202b, a user 202c, and a user 202d all corresponding generally to user 102 of FIG. 1. Additionally, environment 200 includes a device 210a, a device 210b, a device 210c, a device 210d, a device 210e, and a device 210f all corresponding generally to device 110 of FIG. 1.

In environment 200, user 202a may visit hospital location 220, for example, in order to receive medical care. While arriving through an entrance 260, user 202a may be in possession of device 210a, such as a mobile phone, tablet computer, or other communication device. Device 210a may connect with wireless beacon 222a as user 202a passes through entrance 260 and alert a hospital server (not shown) associated with hospital location 220 that device 210a is connected with wireless beacon 222a. Using check-in information from the connection between device 210a and wireless beacon 222a, the server may determine instructions for user 202a, such as a medical chart and/or medical history file for user 202a. Since wireless beacon 222a is located near entrance 260, the medical chart/medical history file may be prepared and provided to hospital device 224a at a check-in desk 262. Thus, a hospital administrative staff 204a may assist user 202a with check-in using the medical chart/medical history file provided by the server.

Additional wireless beacons may be located at sub-areas/locations within hospital location 220. For example, a pharmacy 264 within hospital location 220 includes wireless beacon 222b. Thus, as user 202b arrives at pharmacy 264, device 210b in possession of user 202b may connect with wireless beacon 222b. Device 210b may correspond to a communication device, as discussed above, or may correspond to a tag given to a patient while cared for at hospital location 220 (e.g., a wearable tag, such as a wristband). Once device 210b and wireless beacon 222b connect, the server for hospital location 220 may determine a prescription for user 202b and communicate the prescription to hospital device 224c, such as a monitor that a pharmacist 204c may view in order to fulfill the prescription for user 202b. In various embodiments, 224c may also control fulfillment of the prescription for user 202b, as well as administration of the medication to user 202b.

Patient room 268 may also include a wireless beacon 222d that may be utilized to determine the location of user 202c. For example, wireless beacon 222d may connect with device 210c, such as a wristband or other tag on the person of user 202c. Thus, the server for hospital location 220 may determine that user 202c is located within patient room 268. If user 202c should be located within patient room 268, then the server may not update a hospital device with instructions that user 202c should be located within patient room 268. However, if user 202c exits patient room 268, a hospital device for a staff member assisting user 202c may receive an instruction to move user 202c to patient room 268. In other embodiments, patient room 268 may correspond more generally to a ward or clinic within hospital location 220 for user 202c.

For example, user 202d (e.g., another patient required to be in patient room 268) may exit patient room 268. After exiting patient room 268, device 210d, such as a personal tag, may connect with wireless beacon 222e outside of patient room 268. The server for hospital location 220 may receive the check-in information for the connection between device 210d and wireless beacon 222e. Thus, a health care professional 204b may receive an instruction from the server to relocate user 202d to patient room 268. Hospital device 224b in possession of health care professional 204b may receive the alert and present the alert to health care professional 204b.

Wireless beacons may also be used to monitor the locations and use of hospital equipment, such as medical, diagnostic, and/or surgical equipment. As shown in surgical room 266, a wireless beacon 222c may connect with devices 210e and 210f attached to equipment on a table of surgical room 266. Thus, if another person removes the items/equipment attached to devices 210e and/or 210f (e.g., during a theft of the items/equipment), devices 210e and/or 210f may disconnect from wireless beacon 222c and/or connect to another beacon (e.g., beacon 222a located near entrance 260). The server associated with hospital location 220 may receive the check-in information for the connection between devices 210e and/or 210f and one or more wireless beacons and determine that the items/equipment associated with devices 210e and/or 210f are in an incorrect location. In other embodiments, a health care professional (e.g., a doctor, nurse, etc.) may wish to utilize the items/equipment associated with devices 210e and/or 210f. Thus, if the health care professional brings the items/equipment into surgical room 266, devices 210e and/or 210f may connect to wireless beacon 222c, where instructions for the use of the items/equipment may be communicated to a hospital device.

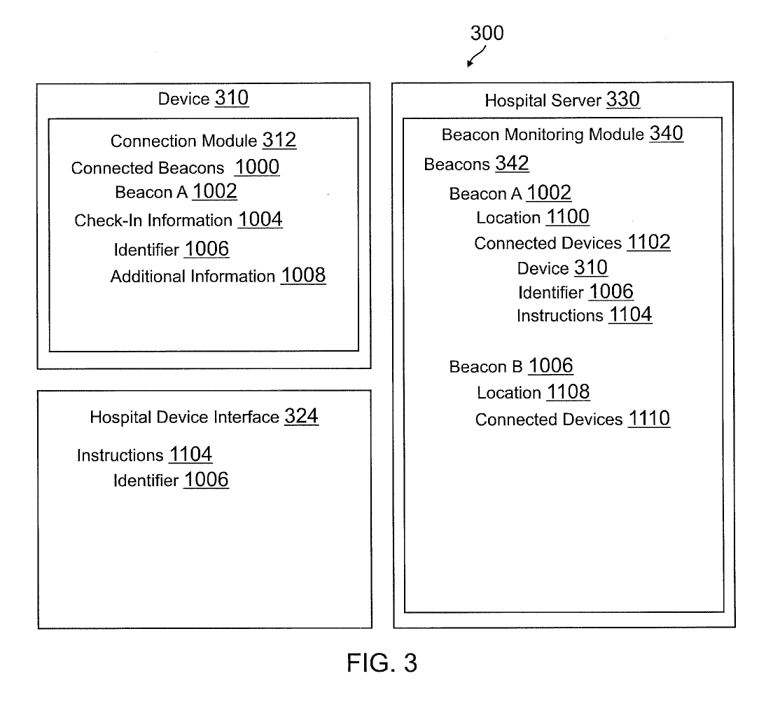

FIG. 3 is an exemplary system environment showing a hospital server detecting a location of a communication device for use in determining user instructions for communication to a hospital device, according to an embodiment. Environment 300 includes a device 310 and a hospital server 330 corresponding generally to device 110 and hospital server 330, respectively, of FIG. 1. Additionally, environment 300 includes a hospital device interface 324 displaying received instructions discussed in reference to hospital devices 124 of FIG. 1.

Device 310 executes a connection module 312 corresponding generally to the specialized hardware and/or software modules and processes described in reference to connection module 312 of FIG. 1. In this regard, connection module 312 may be utilized to form connections with one or more wireless beacons (not shown) for use in providing hospital server 330 check-in information for device 310. Thus, connection module 312 includes connected beacons 1000, which may include information for one or more connected beacons. Connected beacons 1000 includes beacon A 1002, which may be connected to device 310, and which may receive check-in information 1004. Check-in information 1004 may correspond to information provided to beacon A 1002 when device 310 pairs with beacon A 1002 using connection module 312. Thus, check-in information 1004 includes at least identifier 1006, such as an identifier for the user and/or item associated with device, or device 310. In various embodiments, check-in information 1004 may further include additional information 1008, such as identification and/or medical care information, which may further be communicated to hospital server 330 for use in determining instruction associated with device 310.

Hospital server 330 executes a beacon monitoring module 340 corresponding generally to the specialized hardware and/or software modules and processes described in reference to beacon monitoring module 140 of FIG. 1. In this regard, beacon monitoring module 340 may be utilized to determine that a user/item is in proximity to a wireless beacon that device 310 is connected with and access instructions for the user/item based on the connection and location for the wireless beacon. Thus, beacon monitoring module 340 includes information for beacons 342 that beacon monitoring module 340 monitors to receive check-in information. Beacons 342 include beacon A 1002 that device 310 has previously connected with to provide check-in information to hospital server 330. Beacon A 1002 includes information for a location for beacon A 1002, such as location 1100. Location 1100 may be received from beacon A 1002 or may be stored to a database associated with hospital server 330. Additionally, beacon A 1002 includes information for connected devices, such as check-in information for device 310. Thus, beacon A 1002 includes connected device 1102 having device 310, which includes at least identifier 1006 received from device 310. Using connected device 1102, beacon monitoring module 340 may access instructions for device 310, such as from a database of received and/or stored instructions. Thus, communication device 310 is also associated with instructions 1104. As shown in environment 300, beacon monitoring module 340 may also include further monitored wireless beacons, such as at other locations within a hospital. Thus, beacon monitoring module 340 includes information for a beacon B 1106, such as a location 1106 within the hospital and connected devices 1110.

Hospital server 330 may utilize a communication module to communicate instructions 1104 to a hospital device, such as a hospital device associated with hospital device interface 324. Thus, hospital device interface 324 may display instructions 1104, that is the instructions for use with the user/item associated with device 310. Instructions 1104 may be included with identifier 1006 allowing the health care professional viewing hospital device interface 324 to identify the user/item associated with device 310. Further, hospital device interface 324 may be utilized to enter and/or communicate information updating instructions 1104 to hospital server 330.

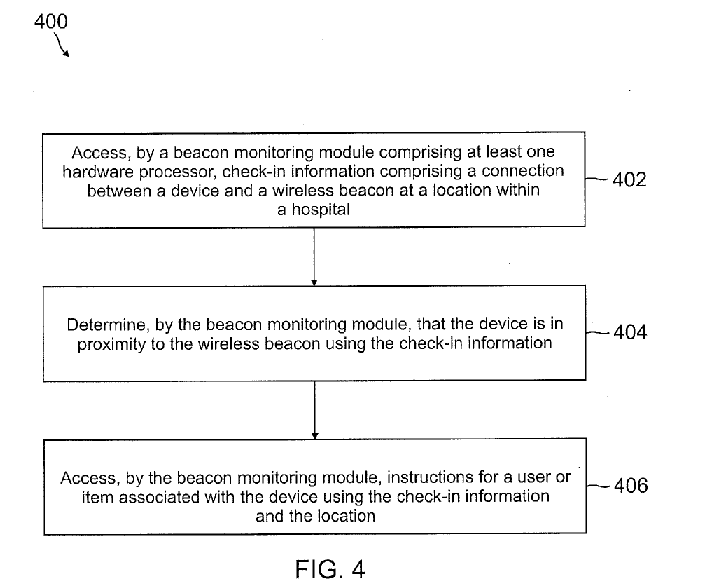

FIG. 4 is a flowchart of an exemplary process for wireless beacon devices used to track medical information at a hospital, according to an embodiment. Note that one or more steps, processes, and methods described herein may be omitted, performed in a different sequence, or combined as desired or appropriate.

At step 402, check-in information comprising a connection between a device and a wireless beacon at a location within a hospital is accessed, by a beacon monitoring module comprising at least one hardware processor. The check-in information may be received via a network interface component and stored to a database. The network interface component may also function as a communication module. The connection may use one of near field communication, radio communication, infrared communication, Bluetooth communication, Bluetooth Low Energy (BLE) communication, LTE Direct communication, and WiFi communication

The device is determined to be in proximity to the wireless beacon using the check-in information, by the beacon monitoring module, at step 404. Thus, at step 406, an instruction for a user or an item associated with the device is accessed using the check-in information and the location, by the beacon monitoring module. The instruction for the user may comprise one of a medical history file for the user, a medical chart for the user, a diagnostic document for the user, a surgical document for the user and a prescription for the user. The instruction may be communicated to a second device for a second user at the hospital. The second user may comprise one of an administrative services employee checking the first user in to the hospital, a nurse at the hospital, a doctor at the hospital, and a pharmacist at the hospital. The network interface component may receive the first instruction from at least one of the second device for the second user and an insurance provider for the first user. Thus, an instruction management module may determine a medical history file comprising at least the first instruction and store the medical history file to the database.

The instruction may comprise a sub-location within the hospital that the user is required to occupy. Thus, the network interface component may further communicate the location to the second device in order to identify the first user with the location to the second user. If the first user moves, the network interface component may further receive second check-in information comprising a second connection between the device of the first user and a second wireless beacon at a second location within the hospital. Thus, the network interface component and/or the beacon monitoring module may update the second device with the second location. The second location may comprise a hospital location outside of the sub-location for the first user. In such embodiments, the beacon monitoring module may generate an alert to the second user that the hospital location is outside of the sub-location, which may be communicated to the second device via the network interface component.

The instruction may comprise a first required medical test for the first user, wherein the second user comprises a first medical care provider administering the first required medical test for the first user. The network interface component may receive a second instruction from the second device of the second user, where an instruction management module may update at least a medical history file for the first user with the second instruction. The medical history file may comprise at least the first instruction before updating with the second instruction. The second instruction comprises at least one of a test result to the first required medical test, a second required medical test, a prescription based on the test result to the first required medical test, and a medical procedure based on the test result to the first required medical test. The network interface component may communicate at least one of the second instruction and the medical history file to at least one of the second device and a third device for a third user comprising a second medical care provider (e.g., another nurse or doctor).

Where the instruction relates to an item, the item may comprise a surgical device for use in a surgical room. Thus, the location may not be within the surgical room, so that the second device is further updated with the location (e.g., to prevent unauthorized use and/or theft). The item may also comprise a medical equipment device. Thus, the instruction may comprise a medical test or use of the medical equipment by a medical care provider viewing the second device at the location. The instruction may further be associated with a user receiving the medical test or use at the location. The item may comprise a medication, thus, the instruction may comprise a prescription or administration of the medication at the location.

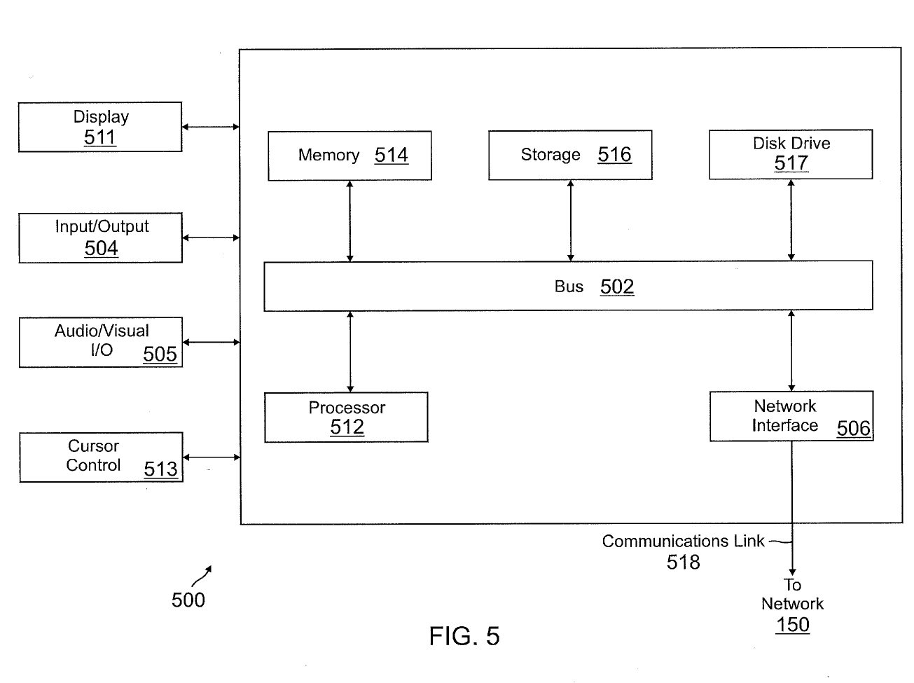

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a beacon monitoring module comprising at least one hardware processor that accesses first check-in information comprising a first connection between a first device and a first wireless beacon at a first location within a hospital, determines that the first device is in proximity to the first wireless beacon using the first check-in information, and accesses a first instruction for a first user associated with the first device using the first check-in information and the first location;
a database stored to a non-transitory memory that stores the first check-in information and the first instructions; and
a network interface component that receives the first check-in information and communicates the first instruction to a second device for a second user at the hospital.

2. The system of claim 1, wherein the first connection uses one of near field communication, radio communication, infrared communication, Bluetooth communication, Bluetooth Low Energy (BLE) communication, LTE Direct communication, and WiFi communication.

3. The system of claim 1, wherein the first instruction comprises one of a medical history file for the first user, a medical chart for the first user, a diagnostic document for the first user, a surgical document for the first user and a prescription for the first user.

4. The system of claim 1, wherein the second user comprises one of a administrative services employee checking the first user in to the hospital, a nurse at the hospital, a doctor at the hospital, and a pharmacist at the hospital.

5. The system of claim 1, wherein the first instruction comprises a sub-location within the hospital that the first user is required to occupy.

6. The system of claim 5, wherein the network interface component further communicates the first location to the second device.

7. The system of claim 5, wherein the network interface component further receives second check-in information comprising a second connection between the first device and a second wireless beacon at a second location within the hospital and updates the second device with the second location.

8. The system of claim 7, wherein the second location comprises a hospital location outside of the sub-location, wherein the beacon monitoring module generates an alert to the second user that the hospital location is outside of the sub-location, and wherein the network interface component communicates the alert to the second device.

9. The system of claim 1, wherein the first instruction comprises a first required medical test, for the first user, and wherein the second user comprises a first medical care provider administering the first required medical test for the first user.

10. The system of claim 9, wherein the network interface component receives a second instruction from the second device, and wherein the system further comprises:
an instruction management module that updates at least a medical history file for the first user with the second instruction, wherein the medical history file comprises at least the first instruction.
wherein the database stores the medical history file.

11. The system of claim 10, wherein the second instruction comprises at least one of a test result to the first required medical test, a second required medical test, a prescription based on the test result to the first required medical test, and a medical procedure based on the test result to the first required medical test.

12. The system of claim 10, wherein the network interface component communicates at least one of the second instruction and the medical history file to at least one of the second device and a third device for a third user comprising a second medical care provider.

13. The system of claim 1, wherein the network interface component receives the first instruction from at least one of the second device for the second user and an insurance provider for the first user, and wherein the method further comprises:
an instruction management module that determines a medical history file comprising at least the first instruction and stores the medical history file to the database.

14. A method comprising:
receiving, via a network interface component, check-in information comprising a connection between a first device and a wireless beacon at a location within a hospital;
determining, by a beacon monitoring module comprising at least one hardware processor, that the first device is in proximity to the wireless beacon using the check-in information;
accessing, by the beacon monitoring module, an instruction for an item associated with the first device using the check-in information and the location; and
communicating, via the network interface component, the instruction to a second device at the hospital.

15. The method of claim 14, wherein the item comprises a surgical device for use in a surgical room.

16. The method of claim 15, wherein the location is not within the surgical room, and wherein the second device is further updated with the location.

17. The method of claim 14, wherein the item comprises a medical equipment device, and wherein the instruction comprises a medical test or use of the medical equipment by a medical care provider viewing the second device at the location.

18. The method of claim 17, wherein the instruction is further associated with a user receiving the medical test or use of the medical equipment at the location.

19. The method of claim 14, wherein the item comprises a medication, and wherein the instruction comprises a prescription or administration of the medication at the location.

20. A non-transitory computer-readable medium comprising executable modules which, in response to execution by a computer system, cause the computer system to perform a method comprising:
receiving, via a network interface component, check-in information comprising a connection between a first device and a wireless beacon at a location within a hospital;
determining, by a beacon monitoring module comprising at least one hardware processor, that the first device is in proximity to the wireless beacon using the check-in information;
accessing, by the beacon monitoring module, instructions for one of a user associated with the first device and an item associated with the first device using the check-in information and the location; and
communicating, via the network interface component, the instructions to a second device at the hospital.
